(19) United States
(12) Patent Application Publication
(10) Pub. No.: US 2009/0045291 A1
(43) Pub. Date: Feb. 19, 2009

(54) INFLATABLE KITE WITH VENTS

(76) Inventor: Ross Davis Harrington, Victoria (CA)

Correspondence Address: J. GORDON THOMSON, P.O. BOX 8865, VICTORIA, BC, V8V 3Z1, CA

(21) Appl. No.: 12/190,473

(22) Filed: Aug. 12, 2008

Related U.S. Application Data
(60) Provisional application No. 60/935,432, filed on Aug. 13, 2007.

(51) Int. Cl. B64C 31/06

(52) U.S. Cl. 244/153 R

(57) ABSTRACT

An inflatable kite uses an inflatable tubular member as a leading edge. The wing is a membrane attached to the front of the leading edge to form a high camber for high lift. Vents in the wing fabric have flaps on them to form nozzles which, when wind is blowing over the kite, cause high pressure air under the kite to exhaust to the top surface of the kite and extend conditions of near laminar flow towards the trailing edge. This increases kite stability and improves stall characteristics.

### CROSS-REFERENCE TO RELATED APPLICATIONS

This application claims the benefit of U.S. Provisional Patent Application No. 60/935,432 filed in the USPTO on Aug. 13, 2007.

### BACKGROUND OF THE INVENTION

1. Field of the Invention

This invention relates to kites used in the sport of kite boarding and more particularly an inflatable kite having vents.

2. Discussion of Prior Art

Kite boarding is a sport where an individual is pulled along the top of the water, snow or land while standing on a small board (approx. 48″×16″×½″) by a kite (approx. 5-20 sq. meters). Kite boarding is a fast growing sport worldwide. Very high speeds can be reached on these boards and they can jump many meters into the air even off a small wave due to the power generated by the kites. Kites now have the ability to have their angle of attack controlled by the rider but this can at times result in the kite stalling because the kite wing is set at too high of an angle of attack to the wind.

Therefore there is a need to improve the aerodynamic stability of the kite at high angles of attack so that the kite does not stall and crash.

### SUMMARY OF THE INVENTION

To solve the problem with unstable airflow over the top surface of the kite wing membrane at high angles of attack, vents have been introduced on an inflatable kite. When vents are placed in a predetermined location on the wing membrane they can delay the onset of stalling by allowing higher pressure air on the underside of the wing membrane to be released onto the top surface of the wing membrane, near the region where the air flow is separating from the top surface of the membrane, and hence keep the air flow attached. This increases the kite's overall wind range as well as making it easier for the rider to fly.

One embodiment of my invention comprises an aerodynamic body comprising a generally elliptical wing formed by a flexible low porosity membrane having a top surface, a bottom surface, a left tip, a right tip and a plurality of vents for venting air from the wing bottom surface to the wing top surface. The wing has a leading edge comprising an inflatable tubular member. The wing also has a trailing edge; and, a plurality of ribs disposed between the leading edge and the trailing edge for supporting a desired geometry of the wing.

### BRIEF DESCRIPTION OF THE DRAWINGS

FIG. 1 is a view of a kite body of one embodiment of the invention.

FIG. 2 is a cross-sectional view of a kite body of another embodiment of the invention.

FIG. 3 is a view of the same embodiment of FIG. 1.

FIG. 4 is two views of vent mesh of embodiments of the invention.

FIG. 5 is a view of a kite body including fabric covers on the vents.

### DETAILED DESCRIPTION

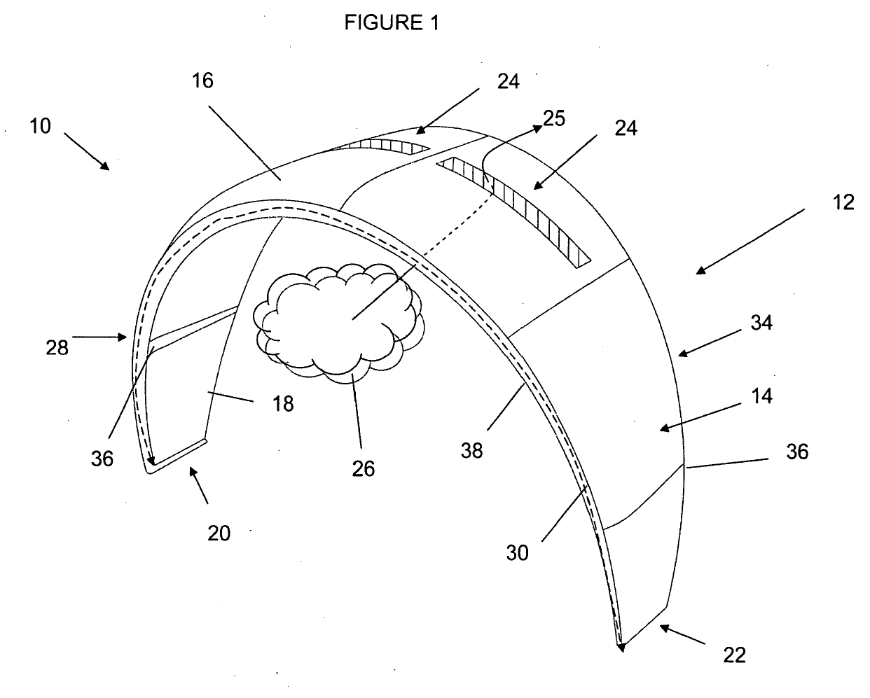

Referring to FIG. 1, my invention is a kite 10 of the type used in kite boarding and related sports. A person familiar with the sport will realize that the drawings accompanying this submission are of the kite only. Additional equipment, not illustrated in this submission, would include kite rigging, a kite board, a control bar and a harness for the user. The kite 10 of my invention comprises an aerodynamic body 12. The aerodynamic body 12 comprises a generally elliptical wing 14 comprising a low porosity membrane having a top surface 16, a bottom surface 18, a left tip 20, a right tip 22 and a plurality of vents 24 for venting 25 high pressure air 26 from underneath the wing bottom surface 18 to the wing top surface 16. The body of my invention further comprises a leading edge 28 comprising an inflatable tubular member 30. There is also a trailing edge 34 opposite the leading edge 28. To provide a desired geometric form and structural support to the wing there is included in my invention a plurality of parallel ribs 36 disposed between the leading edge 28 and the trailing edge 34 of the wing 14.

The inflatable tubular member has a radial length as shown by dashed line 38 connecting said left tip 20 and the right tip 22.

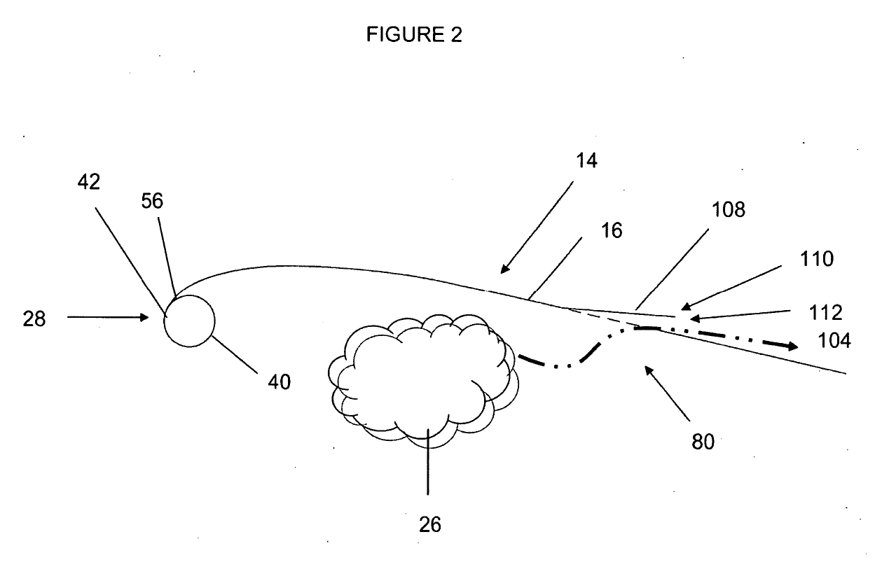

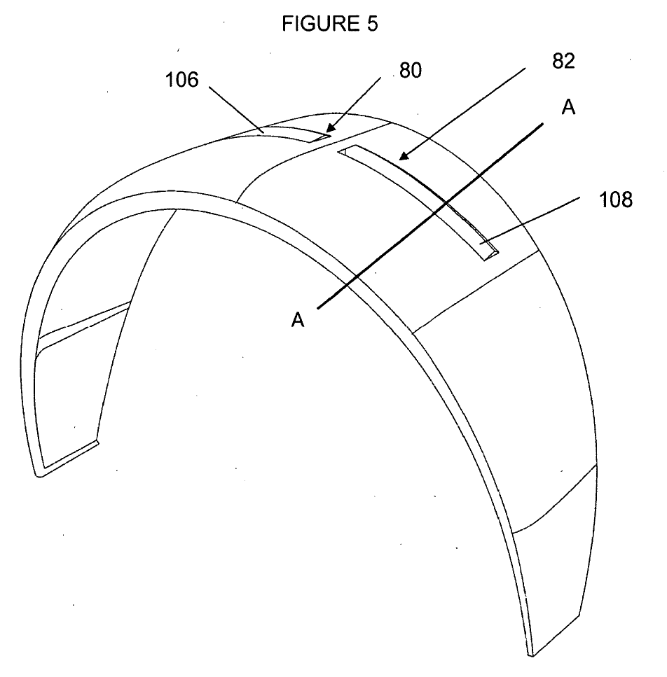

Refer now to FIG. 2 and FIG. 5. FIG. 5 is the same embodiment as FIG. 1 with flap members 106 and 108. As shown in FIG. 2, which is a cross-section of the wing of one embodiment of the invention shown in FIG. 5 at A-A, the generally elliptical wing 14 is fixed to the leading edge 28 at a wing fixing point 56 that is on the front 42 of the outer surface 40 of the inflatable tubular member.

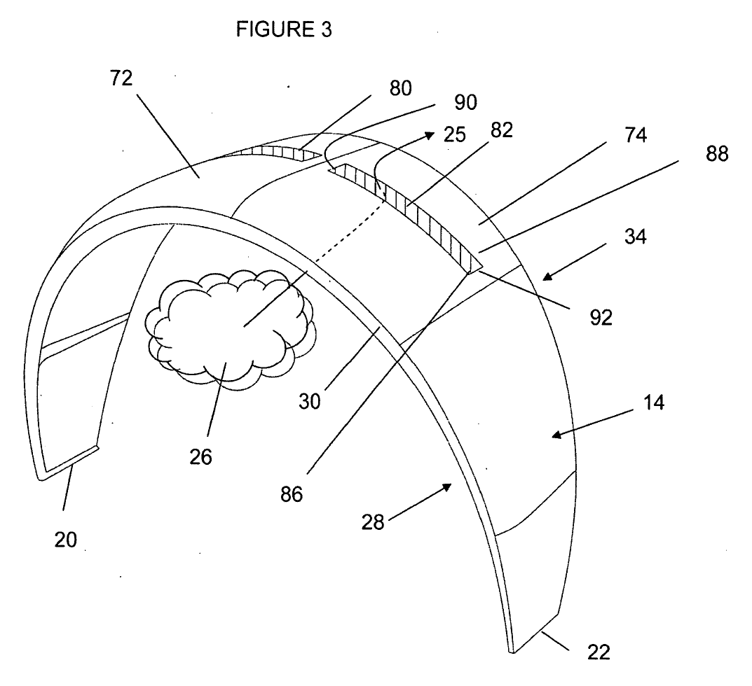

Referring to FIG. 3, which is the same embodiment as in FIG. 1, kite wing 14 has two generally rectangular vents 80 and 82 disposed parallel to the inflatable tubular member 30 from approximately midway to two thirds the distance between the leading edge 28 and the trailing edge 34. In other embodiments of the invention there can be more or fewer vents depending on the desired aerodynamic properties of the wing. In the embodiment illustrated in FIG. 3, the wing has a first opening 80 disposed within the upper left segment 72 of the wing and a second opening 82 disposed within the upper right segment of the wing 74. The first and second vents comprise a leading edge 86 and a trailing edge 88 generally parallel to the inflatable tubular member 30 and a left side edge 90 and right side edge 92 generally parallel to the left 20 and right tips 22 respectively. The vents are covered with a fabric having a large geometric porosity that permits pressurized air 26 flow from the bottom of the wing to the top of the wing 25.

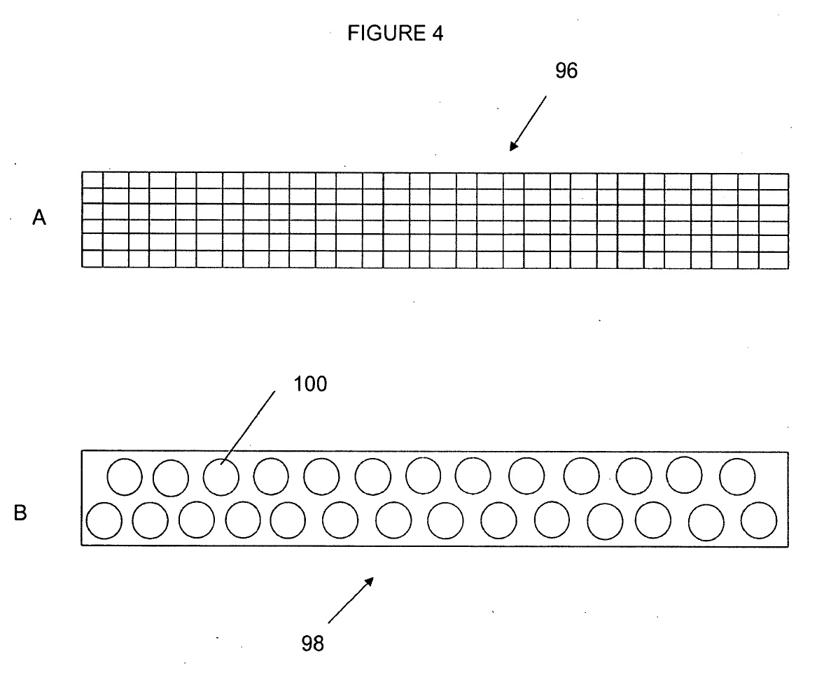

Referring now to FIG. 4, in one embodiment of the invention shown in FIG. 4A the fabric is a mesh fabric 96 having a large geometric porosity. In another embodiment as shown in FIG. 4B the fabric is a perforated fabric 98 with circular perforations 100. In yet another embodiment of the invention, the first and second vents comprise a portion of wing fabric that have been suitably reinforced and perforated for air flow. Alternatively, the vents may be vents without any fabric across them with edges reinforced.

Referring back to FIG. 2, during flight the first opening 80 and the second opening 82 permit high pressure air 26 under the wing 14 to escape to the upper surface 16 of the wing and flow rear-ward 104 along the upper surface as near laminar flow thereby improving aerodynamic performance of the wing at low speeds.

In the embodiment depicted in FIG. 2 and in FIG. 5, the first 80 and second 82 vents are located about two-thirds the distance between the leading edge and the trailing edge and include flap members 106 and 108 fixed to their respective opening leading edges 86, left tips 90 and right tips 92 thereby forming a nozzle 110 as shown in FIG. 2 having an open end 112 for directing air from the lower surface of the wing to the upper surface of the wing and rearward at a velocity sufficient to extend near laminar flow on the upper surface of the wing rearward for improved aerodynamic performance.

Although the description above contains much specificity, these should not be construed as limiting the scope of the invention but as merely providing illustrations of some of the presently preferred embodiments of this invention. Thus the scope of the invention should be determined by the appended claims and their legal equivalents.

What is claimed is:

1. An inflatable kite comprising:
a. an aerodynamic body, said body comprising a wing membrane having a top surface, a bottom surface, a left tip, a right tip and a plurality of vents for venting high pressure air from said membrane bottom surface to said membrane top surface;
b. a leading edge comprising an inflatable tubular member;
c. a trailing edge; and,
d. a plurality of ribs disposed between said leading edge and said trailing edge for supporting a desired geometry of said wing membrane;
e. wherein, during flight, said venting of high pressure air extends laminar or near laminar flow conditions on the top surface of the wing membrane from said plurality of vents to said trailing edge thereby improving stall characteristics of said kite.

2. The kite of claim 1 wherein the wing membrane has a generally elliptical shape.

3. The kite of claim 1 wherein the wing membrane comprises a flexible and substantially non-porous material.

4. The kite of claim 3 wherein the wing membrane is a single piece of material.

5. The kite of claim 1 wherein each vent of said plurality of vents is generally rectangular and disposed approximately parallel to the inflatable tubular member.

6. The kite of claim 5 wherein the plurality of vents is disposed approximately between mid-way and two thirds the distance between the leading edge and the trailing edge.

7. The kite of claim 5 wherein the plurality of vents is disposed approximately two-thirds the distance between the leading edge and the trailing edge.

8. The kite of claim 6 wherein the plurality of vents comprises a first vent disposed within an upper left segment of the wing membrane and a second vent disposed within an upper right segment of the wing membrane.

9. The kite of claim 8 wherein said first and second vents comprise a leading edge and a trailing edge parallel to the inflatable tubular member and a left side and right side edge parallel to the left and right tips respectively.

10. The kite of claim 9 wherein the first vent and the second vent are covered with a fabric having a large geometric porosity.

11. The kite of claim 10 wherein said fabric is a mesh fabric.

12. The kite of claim 10 wherein the fabric is a perforated fabric.

13. The kite of claim 10 wherein the first and second vents comprise a portion of wing that is reinforced and perforated for desired air flow.

14. The kite of claim 9 wherein the first vent and the second vent are voids.

15. The kite of claim 10 wherein during flight the first vent and the second vent permit high pressure air under the wing to escape to the upper surface of the wing and flow rear-ward along the upper surface as laminar or near laminar flow thereby improving aerodynamic performance of the wing at high attack angles.

16. The kite of claim 15 wherein each of the first and second vents include a flap member fixed to their respective vent leading edges, left tips and right tips thereby forming a nozzle having an open trailing end for directing moving air from the lower surface of the wing to the upper surface of the wing and rearward at a velocity sufficient to create laminar or near laminar flow conditions on the upper surface of the wing for improved aerodynamic performance at high attack angles.

17. An inflatable kite comprising:
a. an aerodynamic body, said body comprising a generally elliptical wing membrane comprising flexible and substantially non-porous material having a top membrane surface, a bottom membrane surface, a left tip, a right tip;
b. a plurality of generally rectangular vents disposed within the wing membrane, generally parallel to the inflatable tubular member and approximately two thirds the distance between the leading edge and the trailing edge wherein said vents are adapted for venting high pressure air from said wing bottom surface to said wing top surface;
c. a leading edge comprising an inflatable tubular member;
d. a trailing edge; and,
e. a plurality of generally parallel ribs disposed between said leading edge and said trailing edge for supporting a desired geometry of said wing membrane.

18. An inflatable kite comprising:
a. an aerodynamic body, said body comprising a generally elliptical wing membrane comprising flexible and substantially non-porous material having a top membrane surface, a bottom membrane surface, a centre line, a left tip and a right tip;
b. a leading edge comprising an inflatable tubular member;
c. a trailing edge;
d. a plurality of generally equally spaced and parallel ribs disposed between said leading edge and said trailing edge for supporting a desired geometry of said wing membrane and for creating an equal number of wing segments on each side of said centre line including an upper left segment and an upper right segment; and,
e. a first vent disposed within said upper left segment and a second vent disposed within said upper right segment.

19. The kite of claim 18 wherein said first and second vents comprise a leading edge and a trailing edge parallel to the inflatable tubular member and a left side and right side edge parallel to the left and right tips respectively.

20. The kite of claim 19 wherein each of the first and second vents include a flap member fixed to their respective opening leading edges, left tips and right tips thereby forming a nozzle having an open trailing end for directing moving air from the lower surface of the wing to the upper surface of the wing and rearward at a velocity sufficient to extend near laminar flow conditions on the upper surface of the wing for improved aerodynamic performance at high attack angles.
